(19) United States
(12) Patent Application Publication
(10) Pub. No.: US 2007/0149286 A1
(43) Pub. Date: Jun. 28, 2007

(54) Mobile reality gaming

(76) Inventor: Jeroen Van Bemmel, Zuid Holland (NL)

Correspondence Address: WILLIAMS, MORGAN & AMERSON, 10333 RICHMOND, SUITE 1100, HOUSTON, TX, 77042, US

(21) Appl. No.: 11/319,794

(22) Filed: Dec. 28, 2005

(51) Int. Cl. G06F 19/00

(52) U.S. Cl. 463/41

(57) ABSTRACT

The present invention presents a method for providing mobile gaming in a wireless communication network. The method includes provisioning a virtual game space operable for use with a virtual game. The virtual game space includes a plurality of virtual fields that correspond with cells in at least one wireless communication network. At least one notification of a real world event received from a mobile device of a player of the virtual game is processed, wherein state changes in the virtual game are related to the process events.

### BACKGROUND OF THE INVENTION

1. Field of the Invention

This invention relates generally to communication systems, and, more particularly, to wireless communication systems.

2. Description of the Related Art

Wireless communication systems are commonly employed to provide voice and/or data communications. Existing and emerging wireless communication systems are generally comprised of heterogeneous collections of air-interface technologies, network architectures, and wireless protocols. For example, wireless communication systems may operate using IEEE-802.11 (WiFi) wireless networks that provide access to local area and “hotspot” networks, EEEE-802.16 (WiMax) networks that provide fixed wireless and mobile broadband access, Evolution Data Optimized networks (1×EVDO) that provide access to third generation (3G) mobile data users, and the like.

Mobile operators are continually looking for new sources of revenue from their wireless networks. The classic service offered to subscribers is voice telephony. A vast majority of mobile operators have expanded beyond voice telephony to offer additional services, such as text messaging, video streaming, Internet access, and gaming.

Gaming currently exists in wireless networks in several different forms. In one form, subscribers download and install application software on their mobile devices. Mobile devices may include, for example, cell phones, laptop computers, personal digital assistants (PDAs), text messaging devices, or any other mobile electronic apparatus that permits the subscriber (i.e., user) to move freely while still communicating with the wireless network. Another form of gaming includes question-and-answer games played, for example, using a text messaging service, such as short message service (SMS). In this instance, subscribers are sent questions, and a correct response may generate some type of award, such as additional text minutes, voice minutes, rebates, etc. In a gaming context, mobile operators typically generate revenue by charging for gaming application downloads and/or network access.

An advanced form of gaming relies on global positioning services (GPS) to determine the position of the player in the real world, and this location information is used as an element in the game. This is generally referred to as “location based entertainment.” For example, the game SwordFish, published by Blister Entertainment, uses the GPS capability in a subscriber's mobile device and/or the assisted GPS capability provided by certain wireless networks to determine the player's location. A virtual overlay is used to add virtual fish to the game. The object of the game is to catch a virtual fish by moving around to where the fish are. Mobile operators generate revenue in this gaming scenario by charging for GPS scans and from network access.

Unfortunately, conventional location based gaming is generally only available to subscribers that use relatively advanced mobile devices. GPS capability is gradually finding its way into newer mobile devices, however, a large number of mobile devices in use today do not include this feature. Moreover, the GPS feature increases both the initial cost of the mobile device, and, when used with conventional location based gaming, the subsequent operational cost of the mobile device as well. Therefore, subscribers may choose to forego this feature, especially considering that this capability is not currently used in a large number of other applications. For these subscribers, therefore, the opportunity for mobile operators to generate revenue from location based gaming, using more traditional and more common technology, is lost.

Furthermore, mobile gaming is susceptible to fashion trends. The attention of subscribers is fiercely competed for by mobile operators and other outside influences. Accordingly, the popularity of a game can quickly diminish and take a subservient position to other applications. What is needed, therefore, is the ability to more rapidly create new games including location based games that do not necessarily require sophisticated GPS location capability.

The present invention is directed to addressing the effects of one or more of the problems set forth above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method for providing mobile gaming in a wireless communication network is presented. The method includes provisioning a virtual game space operable for use with a virtual game. The virtual game space includes a plurality of virtual fields that correspond with cells in at least one wireless communication network. At least one notification of a real world event received from a mobile device of a player of the virtual game is processed, wherein state changes in the virtual game are related to the process events.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of an illustrative wireless communication network;

FIG. 2 is a block diagram of a game controller in accordance with one embodiment of the present invention;

FIG. 3 conceptually illustrates one exemplary embodiment of a method for providing mobile gaming in a wireless communication network, in accordance with one embodiment of the present invention;

FIG. 4 is a block diagram of a virtual game space in accordance with one embodiment of the present invention;

FIG. 5 is a simplified representation of two cells in an illustrative wireless communication network.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known-to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

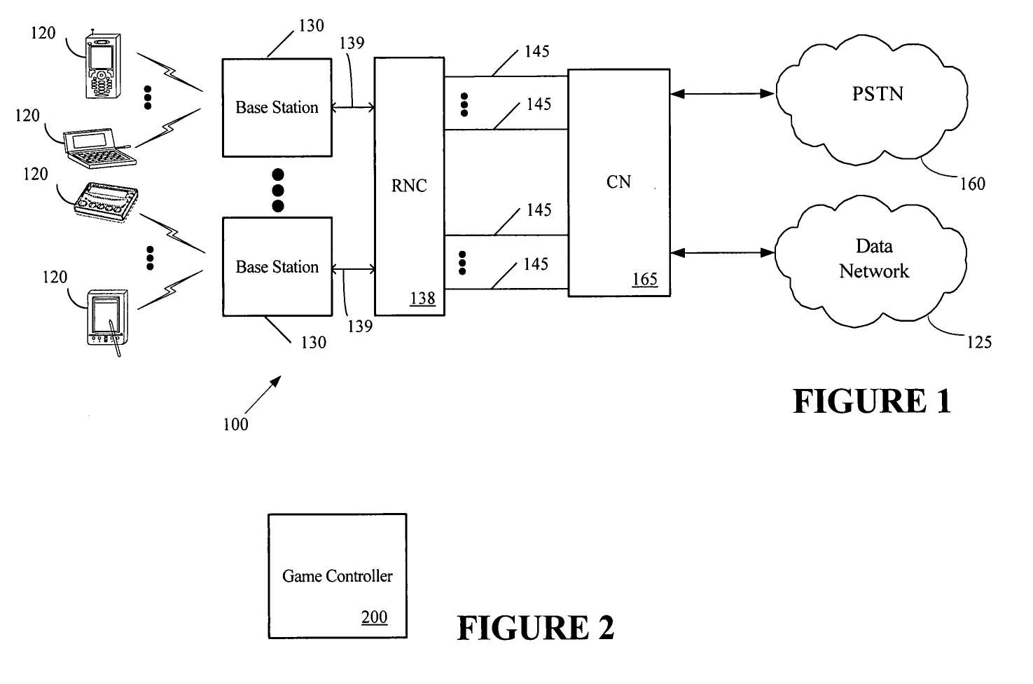

Turning now to the drawings, and specifically referring to FIG. 1, a wireless communications network 100 is illustrated, in accordance with one embodiment of the present invention. The terms “wireless communication network”, “mobile network”, and “wireless network” are used interchangeably herein to generally describe a communication network that is operable to provide mobile communication to its subscribers. For illustrative purposes, the wireless communication network 100 of FIG. 1 is generally compliant with technical specifications and technical reports for a 3^{rd} Generation Mobile System that have been developed by a 3^{rd} Generation Partnership Project (3GPP). Although it should be understood that the present invention may be applicable to other wireless systems that support data and/or voice communications.

The wireless communication network 100 allows one or more mobile devices 120 to communicate with a data network 125, such as the Internet, and/or a Publicly Switched Telephone Network (PSTN) 160 through one or more base stations 130. The mobile device 120 may take the form of any of a variety of devices, including cellular phones, personal digital assistants (PDAs), laptop computers, digital pagers, wireless cards, and any other device capable of accessing the data network 125 and/or the PSTN 160 through the base station 130.

In one embodiment, a plurality of the base stations 130 may be coupled to a Radio Network Controller (RNC) 138 by one or more connections 139, such as T1/EI lines or circuits, ATM circuits, cables, optical digital subscriber lines (DSLs), and the like. Although one RNC 138 is illustrated, those skilled in the art will appreciate that a plurality of RNCs 138 may be utilized to interface with a large number of base stations 130. Generally, the RNC 138 operates to control and coordinate the base stations 130 to which it is connected. The RNC 138 of FIG. 1 generally provides replication, communications, runtime, and system management services. The RNC 138, in the illustrated embodiment handles calling processing functions, such as setting and terminating a call path and is capable of determining a data transmission rate on the forward and/or reverse link for each mobile device 120 and for each sector supported by each of the base stations 130.

The RNC 138 is also coupled to a Core Network (CN) 165 via a connection 145, which may take on any of a variety of forms, such as T1/EI lines or circuits, ATM circuits, cables, optical digital subscriber lines (DSLs), and the like. Generally the CN 165 operates as an interface to a data network 125 and/or to the PSTN 160. The CN 165 performs a variety of functions and operations, such as user authentication, however, a detailed description of the structure and operation of the CN 165 is not necessary to an understanding and appreciation of the instant invention. Accordingly, to avoid unnecessarily obfuscating the instant invention, further details of the CN 165 are not presented herein.

The data network 125 may be a packet-switched data network, such as a data network according to the Internet Protocol (IP). One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 125 may also include other types of packet-based data networks in further embodiments. Examples of such other packet-based data networks include Asynchronous Transfer Mode (ATM), Frame Relay networks, and the like.

Thus, those skilled in the art will appreciate that the wireless communication network 100 facilitates communications between the mobile devices 120 and the data network 125 and/or the PSTN 160. It should be understood, however, that the configuration of the wireless communication network of FIG. 1 is exemplary in nature, and that fewer or additional components may be employed in other embodiments of the communications system 100 without departing from the spirit and scope of the instant invention.

Referring to FIG. 2, a game controller 200 is shown that is operable for controlling mobile gaming functions within a wireless communication network, such as the wireless communication network 100 shown in FIG. 1. Although the game controller 200 is illustrated as a single component, it should be appreciated that the game controller 200 may be comprised of any number of different components that may be cooperatively operable for performing the gaming functions described below. Moreover, the game controller 200 may include new components added to the wireless communication network 100 and/or the game controller 200 may be comprised of existing components within the wireless communication network 100. Likewise, logical positioning and operation of the game controller 200 within the wireless communication network 100 may vary as a matter of design choice. In one illustrative embodiment, however, the game controller 200 is part of the CN 165. In an alternative embodiment, the game controller 200 may be coupled to the data network 125 and operate from a remote location.

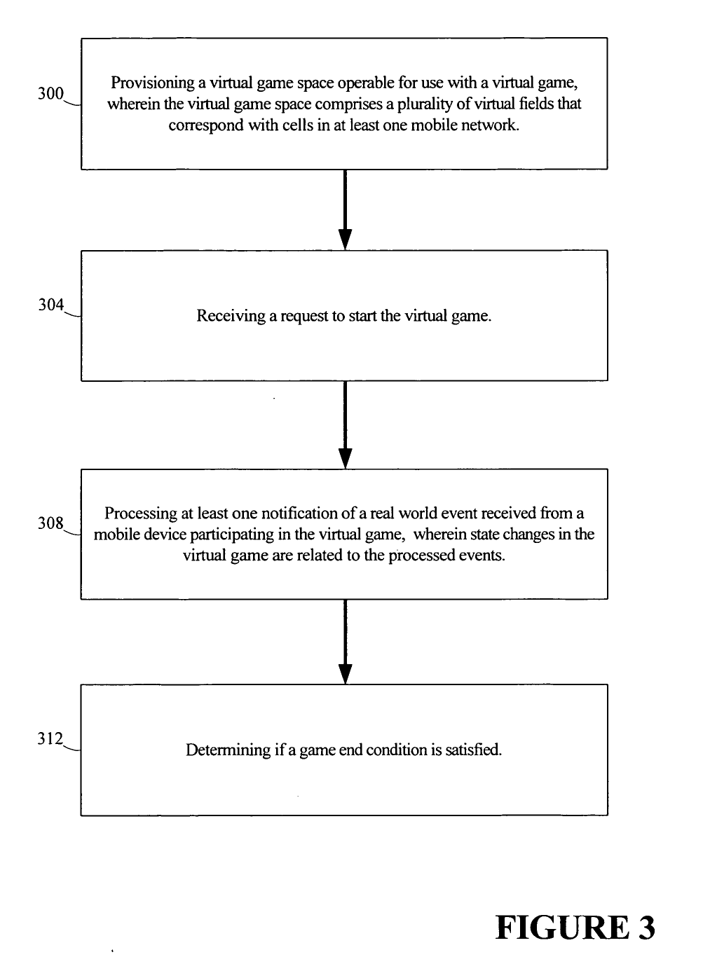

Referring to FIG. 3, an illustrative method of the present invention is shown. For ease of description, the method is described with reference to the game controller 200 and the wireless communication network 100, shown in FIGS. 2 and 1, respectively. It should be appreciated, however, that the method is equally applicable to other wireless networks and may be provisioned using any number of different control arrangements.

At block 300, a virtual game space is provisioned that is operable for use with a virtual game. The virtual game space comprises a plurality of virtual fields that correspond with cells in at least one wireless network, such as the wireless network 100 shown in FIG. 1.

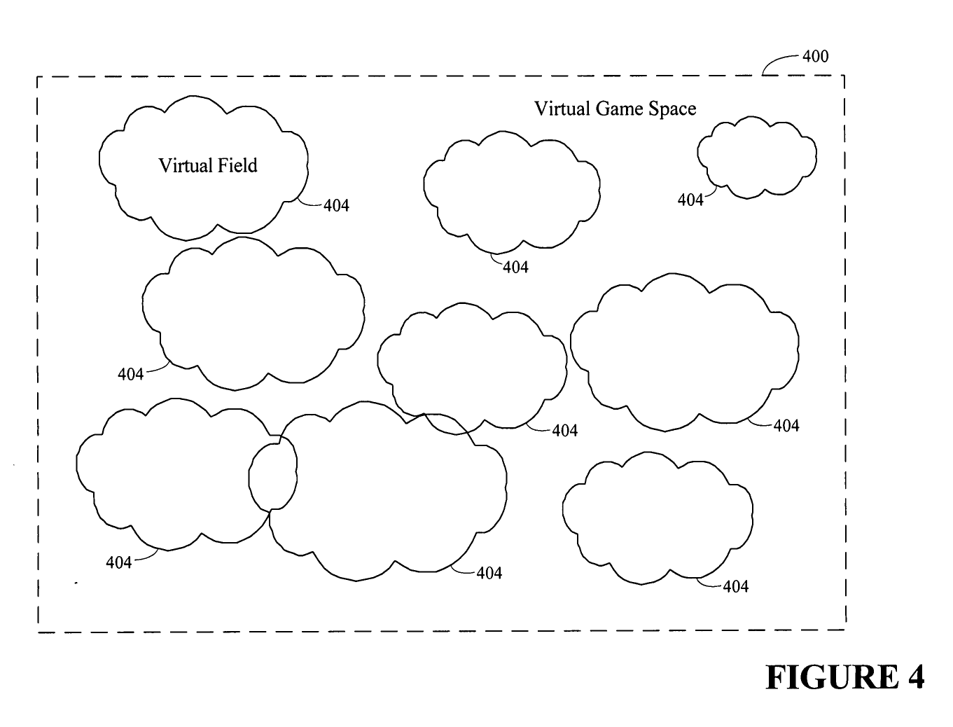

Referring to FIG. 4, for example, a virtual game space 400 is shown that is comprised of a plurality of virtual fields 404. The virtual fields 404 are configured to correspond with cells in at least one wireless network. For example, the virtual fields 404 may map on a one-to-one basis with the cells of a wireless network. With this configuration, if a virtual field 404 is provisioned for each real world cell, the size of the virtual game space 400 will equal the coverage area of the wireless network. In another embodiment, the virtual game space 400 includes virtual fields 404 that correspond with cells from more than one wireless network. In yet another embodiment, the virtual game space 400 may include duplication, wherein a cell in a mobile network is mapped to more than one virtual field 404 and/or where a virtual field 404 is mapped to more than one cell. It should easily be observed that the particular configuration of the virtual game space 400 may be varied as a matter of design choice.

The virtual game space 400 provides a mechanism by which state changes in a virtual game may be related to real world events. In one illustrative embodiment, location based real world events may be processed as inputs to the virtual game. For example, during a game, the game controller 200 may forward commands to a player's mobile device 120, such as “walk west” or “turn left.” When crossing a boundary between two cells, this position change may trigger a notification to the game controller 200. The notification may cause the game controller 200 to execute certain responsive actions as defined by a game program.

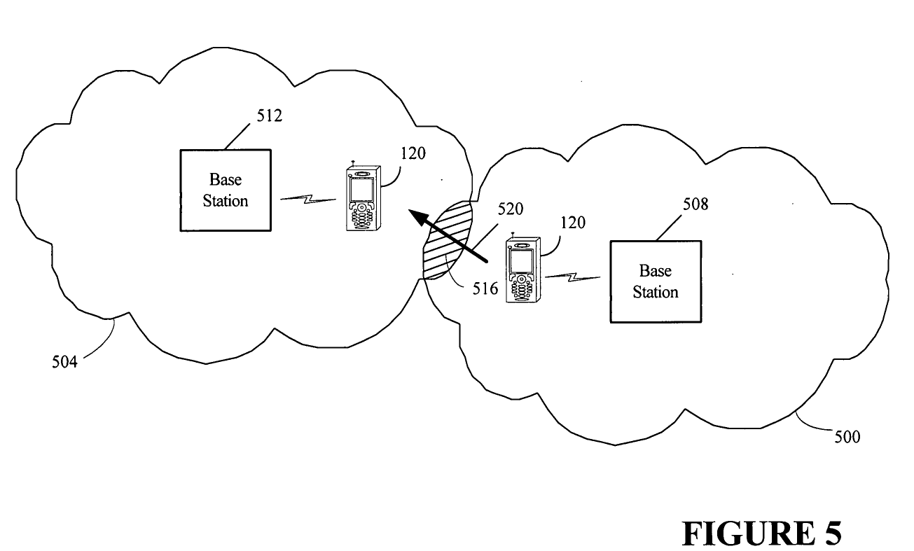

This feature is illustrated in FIG. 5, where, for example, a first cell 500 and a second cell 504 are shown for an illustrative wireless network. As already described, wireless networks are generally comprised of a plurality of cells, and as is known, each cell defines a geographic coverage area of a particular transceiver (e.g., base station, access point, etc.) operating therein. In this example, the first cell 500 and the second cell 504 are formed by base stations 508 and 512, respectively. An overlap zone 516 exists where the first cell 500 and the second cell 504 overlap.

At a first instance in time, a mobile device 120 is shown geographically positioned in the first cell 500 and communicating with the wireless network through the first base station 508. The game controller 200 receives the cell location of the wireless device 120 from the wireless network, and in a location based virtual game, the location of the mobile device is mapped into one or more corresponding virtual fields 404 in the virtual game space 400. At a second instance in time, the mobile device 120 may cross over cell boundaries and move into the second cell 504, illustrated by arrow 520, and the wireless network may handoff servicing of the mobile device 120 from the first base station 508 to the second base station 512. The change in cell location may be acknowledged by the game controller 200 and mapped in the virtual game space 400.

In the overlap zone 516, the mobile device 120 is in both the first cell 500 and the second cell 504. If both the first cell 500 and the second cell 504 are mapped into the virtual game space 400, the game controller 200 may be called upon to resolve which virtual field 404 the mobile device 120 should be assigned. Resolution of this event may vary as a matter of design choice. In one illustrative embodiment, the mobile device 120 is considered to be within the cell corresponding to the base station servicing its mobile communication, and the virtual location of the mobile device 120 is mapped into the virtual game space 400 accordingly.

When the mobile devices 120 moves into the overlap zone 516, the second base station 512 may acknowledge that the mobile device 120 is within the second cell 504, but may not immediately take over responsibility for servicing its mobile communication. Accordingly, the game controller 200 may be configured to wait until handoff is complete before determining that the mobile device 120 has crossed a cell boundary (i.e., a determination that a real world event has occurred). In an alternative embodiment, the cell location of the mobile device 120 may be determined by received signal strength, such that if multiple base stations are in close proximity, the cell location of the mobile device 120 is determined by the base station receiving the strongest signal. In yet another embodiment, when overlap occurs, certain cells may be defined, in the corresponding game space 400, to have priority over other cells. This priority definition may be based on geographic considerations and/or other game conditions (e.g., number of players within a cell, game defined characteristics of the cell, etc.) It should be observed that a variety of different algorithms are possible for determining the cell location of a mobile device 120 and that after this determination is made a change in cell location (i.e., a crossing of a cell boundary) may produce state changes in a virtual game, which is discussed in further detail below.

In addition to cells within a wireless network, other real world points of interest may be mapped into the virtual game space 400. Such real world points of interest may be geographically mapped in the virtual game space 400 and/or mapped according to a game defined logical relationship with the other virtual fields 404. In one illustrative embodiment, the coverage area of one or more 802.11 WiFi access points may be mapped into the virtual game space 400. For example, a wireless access point within a Starbucks or other place of interest may be mapped into the virtual game space 400, and a mobile device 120 may be equipped to report the Media Access Control (MAC) address of detected 802.11 access points. In this manner, the game controller 200 may be alerted that a mobile device 120 is within proximity to a given point of interest. Generally, any transceiver producing a coverage area that is detectable by a mobile device 120 may be mapped into the virtual game space 400.

Real world points of interest mapped into the virtual game space 400 may be fixed or moving. Moving points of interest may include any real world mobile object (e.g., bus, car, train, person, etc.) that is equipped with a wireless transceiver capable of generating a corresponding detectable coverage area. The coverage area moves with the object, which translates into a moving virtual field 404 within the virtual game space 400.

In another embodiment, the mobile device 120 and/or wireless network may be equipped with GPS capability that provides for more accurate locating of players within a game. In this example, points of interest may be more accurately specified and mapped into the virtual game space 400. Real world events are still used to produce state changes in the virtual game, however, events may be more specifically triggered based on proximity to points of interest. Likewise, mobile devices 120 may also be equipped with color screens and the ability to download applications and game code. In this enhanced embodiment, the game programs, discussed below, may be configured to incorporate more sophisticated capabilities.

Referring back to FIG. 3, at block 304, a request is received to start the virtual game. In one illustrative embodiment, a subscriber may send a game request over the wireless network, and continuing with the illustrative examples above, the request may be received by the game controller 200. For example, a request may be comprised of a text message sent to a predetermined game service number (e.g., “GAME TREASUREHUNT ON” sent to number ‘1234’). This information may be processed by the game controller 200 and matched against a set of possible game scenarios that are provisioned. When the game ‘TREASUREHUNT’ is found, the game controller 200 may initiate a new game instance for this game scenario and begin executing the actions defined for the game program. If the game is not found, the controller may send a response message to the requesting mobile device 120 that the game is not found. Otherwise, the requested game becomes active.

In another embodiment, the request to start the virtual game may be self-generating. That is, rather than waiting for a request from a mobile device, the game controller 200 may start a new game on its own. Subscribers may be invited to join an existing game in progress. The invitation may be sent from the game controller 200 or another game participant. For example, the game controller 200 may send voice and/or text message invitations to certain mobile devices 120 based on past usage, account status, geographic location, or any other marketing criteria. In a similar manner, rather than starting a new game, subscribers may request to be joined into an existing game. The game controller 200 may be configured to satisfy the player requirement of a selected game before generating a new instance of the same game.

Once a game becomes active, the illustrative method moves to block 308, of FIG. 3, where notifications of real world events are processed. A game program may be considered in terms of events, conditions, and actions. As defined herein, real world events may be used to trigger state changes in the virtual game. For example, an event notification may be sent from a subscriber's mobile device 120 when the subscriber crosses a cell boundary and enters cell ‘X’. This real world event may translate into a change in the virtual game space 400 if a game program condition is satisfied. Exemplary game conditions may include whether there are more than one player from the same team in cell X, whether cell X has been designated to have special significance, whether cell X was entered within a particular time parameter, etc.

If a condition is satisfied, the game controller 200 may generate a responsive action. In the example above, the action taken by the game controller 200 may be that cell X has been captured by the player's team (i.e., teamOf(P) captures cell X), and the game controller 200 may initiate a second responsive action to send text messages to all team members. In another example, when a player enters a new cell, the game controller 200 may send a clue or hint regarding the direction the player should travel. Similarly, as a responsive action to an event, the game controller 200 may send a text message in the form of a question to a mobile device 120. If the player answers correctly, the game controller 200 may reward the answer with directional information (e.g., travel North).

Even if the event does not impact a game condition (i.e., no responsive action is necessary), the game controller 200 may still update the virtual game space 400 as appropriate. For example, if the player moves into a different cell, the game controller 200 may update the player's location in the virtual game space 400. It should be appreciated that a large variety of events, conditions, and actions are possible and that these variations may be configured into game programs and made available to subscribers of wireless networks.

In one illustrative example, subscribers may play a game referred to as “BountyHunter.” BountyHunter is a two-or-more-player game, where at least one player assumes the role of “Hunter”, and at least one other player assumes the role of “Prey.” The game controller 200 can create and control virtual players that may fulfill either role.

A first player may start the game by sending a request (e.g., “GAME BOUNTYHUNTER ON AS HUNTER”) to the game controller 200. Depending upon the game configuration, the controller 200 may wait until a second player arrives to serve as the role of Prey. After some preset time, if a second player does not enter the game, the game controller 200 may generate a virtual Prey, which it will control throughout the game. The game may begin after at least two players are acknowledged, and the controller 200 may notify the players of the beginning of the game using text messaging.

The game may be configured to allow for any number of Hunters and any number of Preys. Role assignment may be randomized. For ease of game configuration, players may indicate their preferred game play area (e.g., within the same city, province, state, etc.), and this indication may be used to configure the virtual game space 400. If a player moves outside the virtual game space 400, the game controller 200 may send a message indicating this to be the case. The message may also include a suggested direction the player should move to reenter the virtual game space 400.

The object of the exemplary game is for a Hunter to attempt to enter the same cell as a Prey, while the Prey attempts to avoid capture. Periodically, the controller 200 notifies the players of the state of the game. For example, the controller may send periodic text messages to the Hunter that provide its location relative to the Prey (e.g., “Your Prey is north at 1.5 km”). Similarly, the Prey may receive periodic text messages of its position relative to the Hunter (e.g., “Your Hunter is South at 1.5 km”).

In this illustrative example, the Prey wins when it reaches a cell marked as ‘finish’ or after a certain time period has passed without capture. The Hunter is deemed the winner if it enters the same cell as the Prey, within the allotted time period for the game. An award may be offered to the winning player to incentivize subscriber participation in the game. For example, the winning player may be awarded extra voice minutes, text messaging minutes, account credits, or any other prize. A negative reward may be used as well. That is, rewards may be subtracted from the losing opponents account. Players may also suggest a bounty on themselves or their opponent. Moreover, players may challenge another player by sending a voice and/or text message. Clearly, a number of different incentives are possible to encourage player participation.

In another illustrative example, subscribers may play a game referred to as “Cat and Mouse.” In this two-player game, one player assumes the role of “Cat”, while another player assumes the role of “Mouse.” Like BountyHunter, the game controller 200 may provision virtual players. The game is configured at startup by placing a virtual piece of cheese in a chosen cell. To keep the game fair, the cheese may be placed in a cell that is approximately equal distance between the players.

The object of the game is for the Mouse to reach the cell with the cheese before being captured by the Cat. The Mouse wins if it reaches the cell with the virtual cheese first. The Cat wins if it enters the same cell the mouse is in, prior to the mouse finding the cheese. The game may be time limited. As described above, the controller 200 may send periodic messages to the game participants providing game information such as relative location to the cheese and/or the competing player. As described for BountyHunter, a various reward incentives may be used to entice game participation.

In yet another illustrative embodiment, subscribers may play a game referred to as “Treasure Hunt.” Treasure Hunt is a one-or-more-play game where each player assumes the role of “Treasure Hunter.” The controller 200 configures the game by placing a virtual treasure in a cell. The player that reaches the treasure first wins.

During the game, when a player enters a new cell (e.g., triggering an event notification to the processor 200), the controller 200 sends a text message question to the player's mobile device 120. An exemplary question may be “How many provinces does Holland have?” The player may also receive a set of possible answers to choose from, within a given time period. If the correct answer is selected, the game controller 200 replies with a directional hint to the treasure (e.g., “Go north”). If a wrong answer is given, the controller 200 may send a random directional hint to the player, which may be correct but will typically be wrong.

The aforementioned examples illustrate how state changes in a virtual game may be related to real world events. These events may be evaluated in relation to game conditions and a determination may be made whether to generate a responsive action.

The games describe herein, along with other game possibilities, may be realized without modification to existing wireless networks. A typical implementation may rely on the open network Application Programming Interfaces (APIs) of the Parlay group, the 3GPP Open Services Access (OSA), and the like to receive event notifications (e.g., when a player enters or leaves a cell, the switching off of a mobile device, etc.) and to interact with players by sending and receiving text messages and playing voice messages. Moreover, these open network APIs define generic communication functions for rapid application development, while providing abstractions from the details of specific network implementations. This flexibility enables mobile operators and/or third party developers to rapidly create and offer new games and/or modify existing games. Likewise, new landmarks may be easily introduced into a virtual game space. For example, a virtual game space may be modified to include new base stations, game specific landmarks (moving and/or stationary), and integrated with existing games.

Referring back to FIG. 3, at block 312, after a determination that a game end condition is satisfied, the game is concluded. For example, a game may end after a defined time period has passed, after a game participant achieves a defined goal (e.g., reaches a certain cell), fails to achieve a goal (e.g., caught by a virtual predator), etc. Generally, a game end condition may vary as a matter of design choice, and upon receipt of an event notification, the game end condition may be evaluated to determine whether it has been achieved. The game end condition may also be an internally defined event, such as the expiration of a predefined period. It should be appreciated that a number of end conditions may exist for a particular game.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method for providing mobile gaming in a wireless communication network, comprising:
provisioning a virtual game space operable for use with a virtual game, wherein the virtual game space comprises a plurality of virtual fields that correspond with cells in at least one wireless communication network; and
processing at least one notification of a real world event received from a mobile device of a player of the virtual game, wherein state changes in the virtual game are related to the processed events.

2. The method of claim 1, wherein the at least one notification is generated in response to the mobile device crossing a boundary between a first cell and a second cell in the wireless communication network.

3. The method of claim 1, further comprising:
receiving a request to join the virtual game from at least one mobile device in the wireless communication network, wherein the game request is a text message sent over the wireless communication network to a predetermined destination address.

4. The method of claim 1, wherein the state change is a change in a virtual location of the player in the virtual game space.

5. The method of claim 1, wherein the virtual game includes a plurality of game conditions, and processing the at least one notification further comprises:
determining if at least one of the plurality of game conditions is satisfied by the at least one real world event notification; and
if a condition is satisfied, generating a responsive action.

6. The method of claim 5, wherein determining if at least one of the plurality of game conditions is satisfied includes determining whether an end of game condition is satisfied.

7. The method of claim 5, wherein determining if at least one of the plurality of game conditions is satisfied includes determining whether a first player is occupying the same cell as a second player.

8. The method of claim 7, wherein if the game condition is satisfied, the responsive action is a text message to both the first and second player indicating a winner of the virtual game.

9. The method of claim 1, wherein the virtual game is encoded by a game program that uses an open network application programming interface.

10. The method of claim 1, further comprising:
updating the virtual game space with a real world point of interest, wherein the real world point of interest is a moving object equipped with a transceiver for generating a wireless coverage area, and the coverage area of the moving object is mapped into the virtual game space as a corresponding moving virtual field.

11. A method for providing mobile gaming in a wireless communication network, comprising:
provisioning a virtual game space operable for use with a virtual game, wherein the virtual game space comprises a plurality of virtual fields that correspond with cells in at least one wireless communication network; and
processing at least one notification of a real world event received from a mobile device of a player of the virtual game, wherein the virtual game includes a plurality of game conditions, and processing the at least one notification comprises:
determining if at least one of the plurality of game conditions is satisfied by the at least one real world event notification; and
if a condition is satisfied, generating a responsive action.

12. The method of claim 11, wherein the at least one notification is generated in response to the mobile device crossing a boundary between a first cell and a second cell in the wireless communication network.

13. The method of claim 11, wherein the processing of the at least one notification further comprises:
updating a virtual location of the player in the virtual game space.

14. The method of claim 11, further comprising:
updating the virtual game space with a real world point of interest, wherein the real world point of interest is a moving object equipped with a transceiver for generating a wireless coverage area, and the coverage area of the moving object is mapped into the virtual game space as a corresponding moving virtual field.

15. The method of claim 11, wherein the virtual game is encoded by a game program that uses an open network application programming interface.

16. A method for providing mobile gaming in a wireless communication network, comprising:
provisioning a virtual game space operable for use with a virtual game, wherein the virtual game space comprises a plurality of virtual fields that correspond with cells in at least one wireless communication network; and
processing at least one notification of a real world event received from a mobile device of a player of the virtual game, wherein the virtual game includes a plurality of game conditions, and processing the at least one notification comprises:
determining whether a first player is occupying the same cell as a second player; and
if the condition is satisfied, generating a responsive action signaling a winner of the virtual game.

17. The method of claim 16, wherein the at least one notification is generated in response to the mobile device crossing a boundary between a first cell and a second cell in the wireless communication network.

18. The method of claim 16, wherein the processing of the at least one notification further comprises:
updating a virtual location of the player in the virtual game space.

19. The method of claim 16, further comprising:
determining whether an end of game condition has been satisfied; and
if the end of game condition is satisfied, sending a notification that the virtual game has ended.

20. The method of claim 19, wherein the end of game condition is satisfied upon entry of a designated cell by at least one player of the virtual game.
